(19) United States
(12) Patent Application Publication
(10) Pub. No.: US 2014/0359789 A1
(43) Pub. Date: Dec. 4, 2014

(54) Trusted Circle Information Access Management User Interface

(71) Applicant: TeleCommunication Systems, Inc., Annapolis, MD (US)

(72) Inventor: Lance Douglas Pitt, Kent, WA (US)

(73) Assignee: TeleCommunication Systems, Inc., Annapolis, MD (US)

(21) Appl. No.: 14/291,449

(22) Filed: May 30, 2014

Related U.S. Application Data
(60) Provisional application No. 61/828,925, filed on May 30, 2013.

(51) Int. Cl. G06F 21/62; H04L 12/58; G06F 3/0485; G06F 3/0486

(52) U.S. Cl. CPC G06F 21/629; G06F 3/0486; H04L 51/32; G06F 3/0485; G06F 2221/2141
USPC 726/28

(57) ABSTRACT

A user interface to enable subscribers to control dissemination of outgoing information and filter visibility/reception of incoming information, without unduly complicating the interface. The UI enables a subscriber to: assign ranks of trust (ROT) to contacts, stipulate minimum ROT contacts must be assigned to access information shared by the subscriber, and stipulate minimum ROT contacts must be assigned to send information to the subscriber. The UI displays a trusted circle sphere to enable subscribers to assign ROT to contacts. Each line of latitude (LOL) on the sphere represents a separate ROT a contact may be assigned. Contacts are assigned ROT by dragging contact thumbnails onto relevant LOL. The UI additionally displays a ROT graduated color bar to enable subscribers to designate minimum ROT. To designate minimum ROT, a subscriber draws a line from an information item/delivery mechanism displayed on the information control to a ROT on the graduated color bar.

The present invention claims priority from U.S. Provisional No. 61/828,925, filed May 30, 2013, entitled “Trusted Circle Information Access Management User Interface”, the entirety of which is expressly incorporated herein by reference.

### BACKGROUND OF THE INVENTION

1. Field of the Invention

This invention relates generally to safety & security (SSG), but is pertinent to any area in which control of information access is required. The invention specifically pertains to the interface with which subscribers may both stipulate levels of trust required to access their information as well as designate the levels of trust a different subscriber must have to be able to send info to the first subscriber.

2. Background of Related Art

A social network service (e.g., Facebook™, Twitter™, Gtalk™, etc.) is a web-based service over which social network subscribers can communicate and/or share information, e.g., photos, news stories, events, job listings, etc, with other social network subscribers.

A social network subscriber can use various content delivery mechanisms, e.g., email, instant message (IM) service, etc., to communicate and/or share content with other social network subscribers. For instance, a user subscribed to a social network service may create a web profile that is viewable by other social network subscribers. To share content, a social network subscriber may then post, e.g., information, quotes, photos, news articles, etc., on their own web profile or on other social network subscribers' web profiles, web feeds, forums, etc. Shared content may then be visible on other social network subscribers' news feeds (i.e. continuously updated feeds that notify users of content shared by other social network subscribers), web profiles, etc.

For safety, security, and perhaps even personal reasons, a social network subscriber may at times wish to filter contacts with whom they share certain information. For instance, a social network subscriber may only wish to share details of a family vacation with close friends, so as to avoid broadcasting to their entire social network that they are on vacation (and that their house is vacant). Moreover, for personal reasons, a social network subscriber may wish to censor a particular contact, e.g., a boss, teacher, etc., from certain content published on their social network web profile. A social network subscriber may also wish to decline notification of content posted (shared) by certain social network subscribers, e.g., members that tend to post lame content, too much content, inappropriate content, etc.

Several companies have developed user interfaces that allow subscribers to filter receipt/visibility of inbound content (e.g. content sent to a subscriber via email, news feed, instant messenger (IM), etc.) and/or control dissemination of outbound content (e.g. subscriber-originated content shared on a social network). For instance, Microsoft™ implemented a user interface that enables Microsoft™ Internet Explorer users to control the manner in which outgoing content is presented to other Microsoft™ Internet Explorer users. The Microsoft™ user interface also enables users to control dissemination of web-cookie information. Unfortunately, information presentation and web-cookie dissemination controls provided by Microsoft™ are not sufficient to manage a fully-featured trusted circle.

Google™ has also developed a user interface that permits users to control dissemination of outgoing information. In particular, Google™ has built a Google Circles™ user interface, with which a google mail or google talk user can develop contact groups. Google Circles™ subscribers can use contact groups to filter receipt/visibility of inbound content (e.g. a subscriber may indicate specific contact groups from which inbound announcements/content may be made visible) and/or control dissemination of outbound content (e.g. a subscriber may indicate specific contact groups to which outbound announcements/content may be made visible).

Hence, the Google Circles™ user interface acts much like a filter mechanism, to enable subscribers to control to whom subscriber-originated content may be shared and from whom inbound content may be received.

Unfortunately, Google Circles™ has not been ubiquitously adopted by the public. Apparently, Google Circles™ makes it very easy to add a contact to a circle, but exceedingly difficult to remove a contact from a circle. This asymmetric control skew of the Google Circles™ user interface has rendered the interface non-intuitive (and frankly annoying).

### SUMMARY OF THE INVENTION

A user interface to enable subscribers/device users to control access to their outgoing (shared) content and to designate controls for the visibility/receipt of incoming content, without unduly complicating the interface, comprises a trusted circle information access management user interface.

In accordance with the principles of the present invention, the trusted circle information access management user interface enables a subscriber/device user to: assign ranks of trust (ROT) to contacts (e.g. subscribers/device users within the subscribers' social network), stipulate a minimum rank of trust (ROT) contacts must be assigned (by the subscriber) to be permitted to access content shared by the subscriber (e.g. content posted to social network by the subscriber), and stipulate a minimum rank of trust (ROT) contacts must be assigned (by the subscriber) to be permitted to send content (e.g., emails, instant messages (IM), status updates, etc.) to the subscriber.

The inventive trusted circle information access management user interface preferably comprises two settings: a ranks of trust (ROT) setting and an information control setting.

In accordance with the principles of the present invention, the ranks of trust (ROT) setting on the trusted circle information access management user interface displays a trusted circle sphere to enable subscribers to assign ranks of trust (ROT) to contacts. In particular, the inventive trusted circle sphere displays one or more lines of latitude that each represent a separate rank of trust (ROT). To assign a contact a rank of trust (ROT), a subscriber drags a contact thumbnail representing the contact onto a line of latitude corresponding to a desired rank of trust (ROT). Lines of latitude displayed in the northern hemisphere of the trusted circle sphere preferably represent increasing levels of trust, whereas lines of latitude displayed in the southern hemisphere of the trusted circle sphere preferably represent increasing levels of distrust.

In accordance with the principles of the present invention, an information control on the trusted circle information access management user interface comprises a ranks of trust (ROT) graduated color bar to enable subscribers to designate a minimum rank of trust (ROT) contacts/groups of contacts must be assigned to be permitted to access content shared by the subscriber and/or to be permitted to send content to the subscriber.

In particular, information items a subscriber may wish to share with other contacts/device users, and delivery mechanisms by which a subscriber may receive information from other contacts/device users, are displayed on the information control. To designate a minimum rank of trust (ROT) a contact/group of contacts must be assigned to be permitted access to an information item shared by the subscriber and/or to be permitted to send information to the subscriber via an available delivery mechanism, a subscriber need simply draw a line from the information item/delivery mechanism displayed on the information control to a desired rank of trust (ROT) on the ranks of trust (ROT) graduated color bar. The northern portion of the graduated color bar preferably represents increasing levels of trust, whereas the southern portion of the graduated color bar preferably represents increasing levels of distrust.

### BRIEF DESCRIPTION OF THE DRAWINGS

Features and advantages of the present invention will become apparent to those skilled in the art from the following description with reference to the drawings, in which:

FIG. 1 depicts an exemplary ranks of trust (ROT) tab on a trusted circle information access management user interface, in accordance with the principles of the present invention.

FIG. 2 depicts an exemplary trusted circle sphere that has been tilted upward, in accordance with the principles of the present invention.

FIG. 3 depicts an exemplary information control on a trusted circle information access management user interface, in accordance with the principles of the present invention.

### DETAILED DESCRIPTION OF ILLUSTRATIVE EMBODIMENTS

The present invention comprises a trusted circle information access management user interface to enable subscribers/device users to control dissemination of outgoing (shared) information and to enable subscribers/device users to filter reception/visibility of incoming information, without unduly complicating the interface.

Conventional user interfaces offering subscriber information dissemination control capabilities have not been ideally received by the public. In particular, conventional user interfaces have not exemplified extraordinary ease-of use and sufficient intuitive representation qualities so as to stimulate wide spread adoption of the underlying technology. The present inventors have realized that public adoption of a new technology has as much to do with the ease of use of the technology, as it does to do with the features/services provided by the technology.

The inventive trusted circle information access management user interface is an intuitive user interface that enables a subscriber to: assign ranks of trust (ROT) to contacts (e.g. subscribers/device users within the subscribers' social network), stipulate a minimum rank of trust (ROT) contacts must be assigned (by the subscriber) to be permitted to access content shared by the subscriber (e.g. content posted by the subscriber on a social network), and stipulate a minimum rank of trust (ROT) contacts must be assigned (by the subscriber) to be permitted to send content (e.g., emails, instant messages (IM), status updates, etc.) to the subscriber.

The juxtaposition of mapping contacts to ranks of trust (ROT) and mapping specific information items and/or delivery mechanisms to minimum ranks of trust (ROT), as provided within the present invention, allows information sharing applications and information receiving applications to easily determine how much information may be shared, and/or from whom (e.g. from which specific contacts) information may be received (per available delivery mechanism) for a given subscriber.

A trusted circle information access management user interface preferably includes two settings: a ranks of trust (ROT) setting and an information control setting.

The ranks of trust (ROT) setting on the inventive trusted circle information access management user interface permits a subscriber to assign contacts and/or groups of contacts (e.g. contacts/devices users within the subscribers' social network) to desired ranks of trust (ROT). Moreover, the information control setting on the trusted circle information access management user interface enables a subscriber to stipulate a minimum rank of trust (ROT) contacts or groups of contacts must be assigned to be permitted access to the subscribers' outbound (shared) content (e.g. social network posts, announcements, etc.), and a minimum rank of trust (ROT) contacts or groups of contacts must be assigned to be permitted to send content (e.g. email, instant messages (IM), facebook™ pokes, etc.) to the subscriber.

The combination of the two tabs on the trusted circle information access management user interface enables a subscriber to easily designate specific contacts/groups of contacts with whom information may be shared, and specific contacts/groups of contacts from whom information may be received and/or made visible to the subscriber. The dual tab infrastructure on the trusted circle information access management user interface is both straight forward and easy to use.

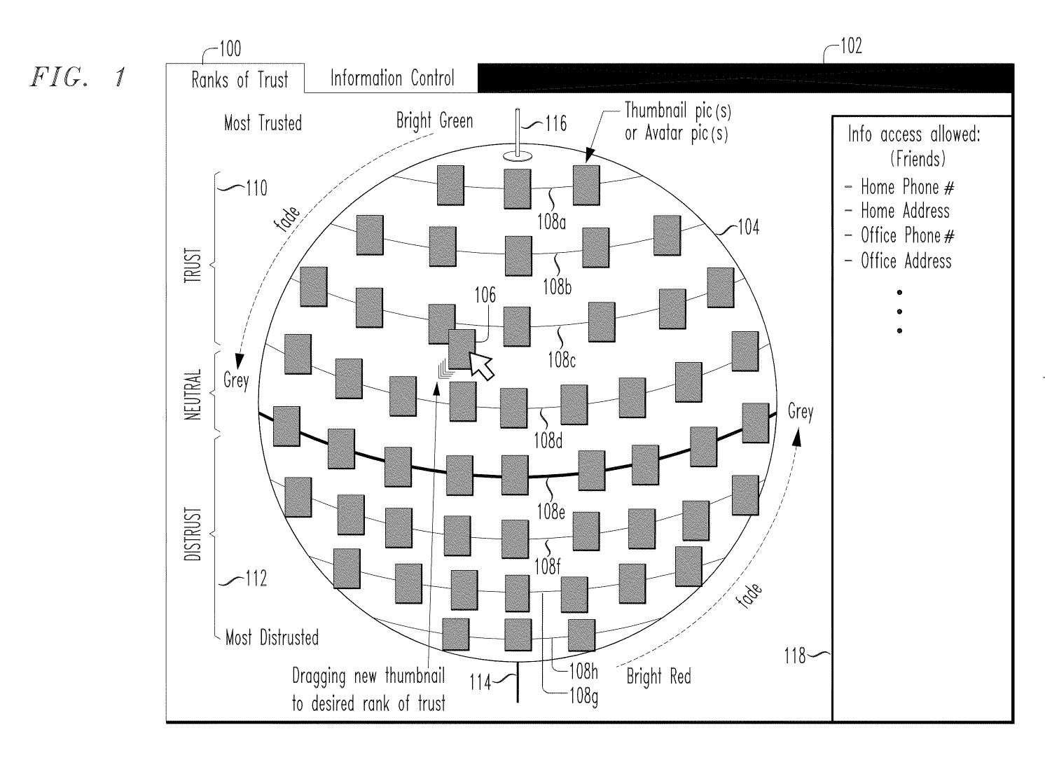

FIG. 1 depicts an exemplary ranks of trust (ROT) tab on a trusted circle information access management user interface, in accordance with the principles of the present invention.

As shown in FIG. 1, a ranks of trust (ROT) tab 100 on the trusted circle information access management user interface 102 comprises a trusted circle sphere (a spherical representation) 104 that displays contact thumbnails 106 for all contacts assigned a rank of trust (ROT) by a subscriber. In accordance with the principles of the present invention, each line of latitude 108a-108h displayed on the inventive trusted circle sphere 104 represents a separate rank of trust (ROT) a contact may be assigned. Contacts thumbnails 106 for contacts assigned a rank of trust (ROT) are displayed on a line of latitude 108a-108h representing that rank of trust (ROT).

As depicted in FIG. 1, the trusted circle sphere 104 on the ranks of trust tab 100 comprises a northern hemisphere 110 and a southern hemisphere 112. Lines of latitude 108a-108d positioned in the northern hemisphere 110 of the trusted circle sphere 104 preferably represent increasing ranks of trust (ROT), whereas lines of latitude 108f-108h positioned in the southern hemisphere 112 of the trusted circle sphere 104 preferably represent increasing ranks of distrust (ROT).

In accordance with the principles of the present invention, a line of latitude 108h positioned at the southernmost tip (i.e. south pole) 114 of the trusted circle sphere 104 preferably represents a lowest rank of trust (ROT) a contact may be awarded. This southernmost line of latitude 108h is preferably reserved for contacts a subscriber strongly dislikes and/or distrusts. Alternatively, a line of latitude 108a positioned at the northernmost tip (i.e. north pole) 116 of the trusted circle sphere 104 preferably represents a highest rank of trust (ROT) a contact may be awarded. This northernmost line of latitude 108a is preferably reserved for contacts a subscriber likes and/or trusts most. Therefore, the greater the value, or more northernly situated (i.e. closer to the north pole 116) a contact is located on the trusted circle sphere 104, the more that contact is considered liked and/or trusted by a subscriber, whereas the lesser the value, or more southernly situated (i.e. closer to the south pole 114) a contact is located on the trusted circle sphere 104, the more that contact is considered disliked and/or distrusted by the subscriber. The equator 108e (i.e. central line of latitude) on the trusted circle sphere 104 is preferably reserved for contacts about whom a subscriber is neutral.

Contact thumbnails 106 depicting contacts known to a subscriber (e.g. contacts/device users in a subscribers' personal/social network) are preferably displayed in a pool of available/unranked contacts (not shown) on the ranks of trust (ROT) tab 100 or on lines of latitude 108a-108h corresponding to assigned ranks of trust (ROT) (when applicable). Group thumbnails (aka group icons) 106 may also be displayed on the trusted circle sphere 104. Group thumbnails 106 are used to represent a group of two or more contacts. Contact thumbnails/group thumbnails 106 presented on the trusted circle information access management user interface 102 preferably display thumbnail pictures (or avatar pictures) of contacts/groups for which they are used to represent.

In accordance with the principles of the present invention, a subscriber assigns a desired rank of trust (ROT) to a contact/group of contacts, or alters a rank of trust (ROT) previously assigned to a contact/group of contacts, by dragging a contact/group thumbnail 106 depicting the contact/group onto a relevant line of latitude 108a-108h.

Contact thumbnails and/or group thumbnails 106 may be dragged up or down the trusted circle sphere 104 from rank to rank. Moreover, the entire trusted circle sphere 104 can be tilted upward or downward, to increase or decrease visibility of a particular hemisphere 110, 112 of the sphere 104, by grabbing the equator 108e of the sphere 104 and pulling up or down. When the trusted circle sphere 104 is tilted downward (as shown in FIG. 1), the northern hemisphere 110 of the sphere 104 is more visible than the southern hemisphere 112. Alternatively, when the trusted circle sphere 104 is tilted upward, the southern hemisphere 112 of the sphere 104 is more visible than the northern hemisphere 110.

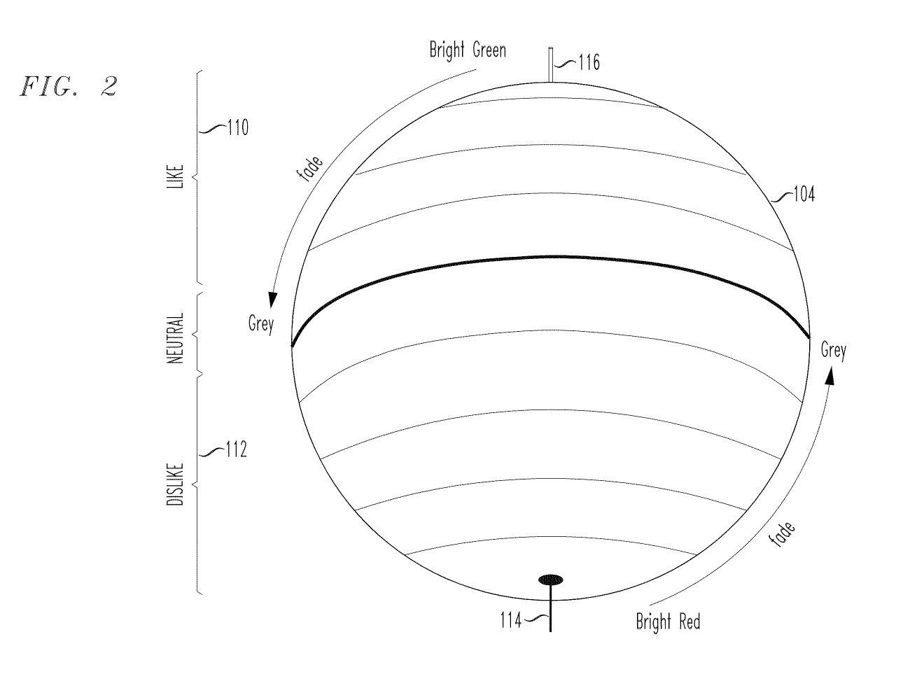

FIG. 2 depicts an exemplary trusted circle sphere that has been tilted upward, in accordance with the principles of the present invention.

As depicted in FIG. 2, the southern hemisphere 112 of the trusted circle sphere 104 is more visible than the northern hemisphere 110, as a result of the sphere 104 having been tilted upward.

Lines of latitude 108a-108h on the inventive trusted circle sphere 104 preferably display an odd number of contact thumbnails/group thumbnails 106, so that one thumbnail 106 is always positioned in the exact center of the line of latitude 108a-108h, with an even number of contact thumbnails/group thumbnails 106 displayed to the right and left of the center thumbnail 106.

In accordance with the principles of the present invention, double clicking a contact thumbnail 106 on the trusted circle information access management user interface 102 opens a details popup window (not shown), comprising details about the contact. Alternatively, double clicking a group thumbnail 106 on the trusted circle information access management user interface 102 opens a group popup window (not shown) that displays all members of the group.

If a double clicked contact thumbnail/group thumbnail 106 is not positioned front and center on a line of latitude 108a-108h on the trusted circle sphere 104, then the line of latitude (rank line) 108a-108h is preferably spun so that the contact thumbnail/group thumbnail 106 is displayed front and center. Moreover, if a hemisphere 110, 112 in which a double clicked contact thumbnail/group thumbnail 106 is positioned is tilted away/out of focus, then the trusted circle sphere 104 is preferably tilted, up or down as is necessary, to focus the sphere 104 on the hemisphere 110, 112 in which the double clicked contact thumbnail/group thumbnail 106 is positioned.

The ranks of trust (ROT) tab 100 on the trusted circle information access management user interface 102 preferably includes a search function (not shown) to allow users to quickly identify contacts (listed individually or in a group).

In accordance with the principles of the present invention, contact/group thumbnails 106 assigned to a particular rank of trust (ROT) need not all be visible on the trusted circle sphere 104 at once. In particular, the trusted circle sphere 104 on the inventive trusted circle information access management user interface 102 displays as many contact thumbnails/group thumbnails 106 as can fit horizontally on a line of latitude 108a-108h, regardless of display screen size. The same spherical solution can scale for various display screens, e.g., smart phone displays screens, tablet display screens, PC display screens, etc. When contact thumbnails/group thumbnails 106 assigned to a particular rank of trust (ROT) cannot all be displayed on a corresponding line of latitude (for lack of room), subscribers can scroll through contacts/groups of contacts assigned to that rank of trust (ROT) by spinning the line of latitude 108a-108h. Contact thumbnails/group thumbnails 106 are preferably situated on a line of latitude 108a-108h so as to provide enough horizontal spacing therebetween to allow a subscriber to grab the underlying line of latitude 108a-108h and spin the contact thumbnails/group thumbnails 106 in either direction (e.g. right or left).

For leftward scrolling, more contact thumbnails/group thumbnails 106 are pulled in on the right side of a line of latitude 108a-108h, while contact thumbnails/group thumbnails 106 are simultaneously removed from the left side of the line of latitude 108a-108h. Alternatively, for rightward scrolling, more contact thumbnails/group thumbnails 106 are pulled in on the left side of a line of latitude 108a-108h, while contact thumbnails/group thumbnails 106 are simultaneously removed from the right side of the line of latitude 108a-108h.

In accordance with the principles of the present invention, each line of latitude 108a-108h displayed on the trusted circle sphere 104 can be spun separately to scroll through contacts/groups 106 assigned thereto. A user need not spin the entire trusted circle sphere 104 to scroll through members of a single rank of trust (ROT).

If a rank of trust (ROT) contains so few contacts that all contacts in the rank can be displayed horizontally on a line of latitude 108a-108h, even when only a portion of the trusted circle sphere 104 is fully visible (e.g. the sphere 104 is tilted), then that line of latitude 108a-108h is not able to be spun (for scrolling). A line of latitude 108a-108h that cannot be spun may display an even number of contact thumbnails/group thumbnails 106.

In accordance with the principles of the present invention, a group popup window (displayed when a group thumbnail 106 is double clicked) preferably exhibits the same horizon capabilities as the trusted circle sphere 104. In particular, a group popup window only displays as many contact thumbnails 106 as can fit horizontally on the popup window. Contacts thumbnails 106 can then be scrolled through so as to allow all contact thumbnails 106 to be viewed. Contact thumbnails 106 are preferably displayed in a ferris wheel structure for scrolling.

A new contact can be added to a group by dragging a contact thumbnail 106 representing the contact on to the top of a group thumbnail 106 representing the group. Likewise, a contact can be removed from a group by dragging a contact thumbnail 106 representing the contact out of a group popup window (and onto a desired line of latitude or into a pool of available/unranked contacts) displayed for the group.

In accordance with the principles of the present invention, a contact cannot be assigned to more than one rank of trust (ROT). Moreover, a contact cannot be both a member of a group and listed individually, nor can a contact be included in more than one group. A contact need not be included in any groups.

All lines of latitude 108a-108h available on the trusted circle sphere 104 are preferably displayed at all times so as to keep the display looking clean and to prevent ranks from overlapping.

In accordance with the principles of the present invention, the rank of trust (ROT) tab 100 on the inventive trusted circle information access management user interface 102 also preferably displays an information access allowed box 118 whenever: a user clicks, touches, or hovers over a line of latitude 108a-108h displayed on the trusted circle sphere 104. An information access allowed box 118 lists all information to which contacts in a relevant/selected/hovered line of latitude 108a-108h/rank of trust (ROT) are permitted access.

In accordance with another aspect of the present invention, the trusted circle information access management user interface 102 preferably contains underlying analytics that are used to assign a recommended rank of trust (ROT) to each new contact added to the inventive user interface 102. In particular, underlying analytics are used to evaluate characteristics of newly added contacts, and evaluated characteristics are then used to recommend an initial rank of trust (ROT).

Analytics for assigning an initial rank of trust (ROT) to a newly added contact preferably take into account relationship information (e.g. spouse, child, parent, cousin, uncle, etc.), link information (e.g. from LinkedIN™), and friend information (e.g. from facebook™) accumulated for the newly added contact.

For instance, a new contact might be assigned a starting numerical trust value of, e.g., −90.0, or −70.0, etc. Then, with each new relationship detected for the contact, positive value may be added to the contacts' running numerical score. A resulting numerical trust value computed for a newly added contact is directly mapped to a coincident rank of trust (ROT).

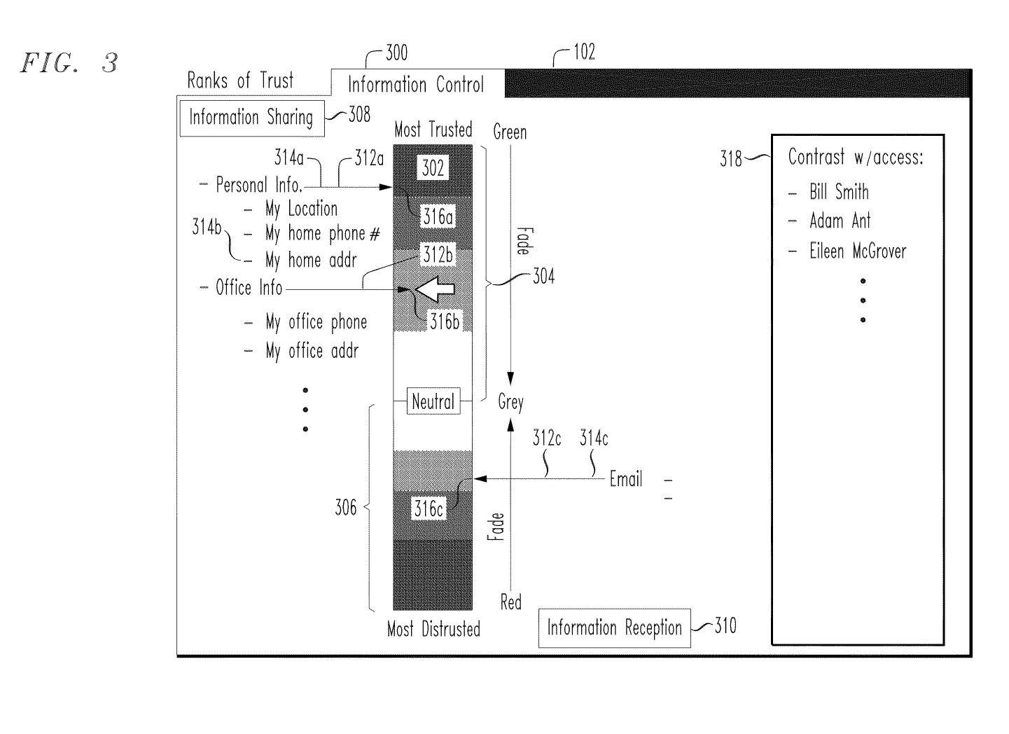

FIG. 3 depicts an exemplary information control on a trusted circle information access management user interface, in accordance with the principles of the present invention.

As portrayed in FIG. 3, an information control 300 on the trusted circle information access management user interface 102 displays a ranks of trust (ROT) graduated color bar 302. In accordance with the principles of the present invention, a subscriber preferably uses the ranks of trust (ROT) graduated color bar 302 to define a minimum rank of trust (ROT) a contact or group of contacts must be assigned to access content published/shared by the subscriber and/or to designate a minimum rank of trust (ROT) a contact or group of contacts must be assigned to send content (e.g. emails, social network posts, facebook™ pokes, etc.) to the subscriber. The southern portion 306 of the ranks of trust (ROT) graduated color bar 302 preferably represents increasing levels of distrust, whereas the northern portion 304 of the ranks of trust (ROT) graduated color bar 302 preferably represents increasing levels of trust.

As depicted in FIG. 3, the information control 300 on the trusted circle information access management user interface 102 also displays an information sharing area 308 and an information reception area 310. The information sharing area 308 on the information control 300 lists all information items a subscriber may wish to share with contacts (e.g. contacts/device users in the subscribers' social network). Moreover, the information reception area 310 on the information control 300 lists all delivery mechanisms (e.g. email, instant message (IM), etc.) by which a subscriber may receive information from contacts (e.g. contacts/device users in the subscribers' social network).

In accordance with the principles of the present invention, a subscriber assigns delivery mechanisms listed in the information reception area 310, and information items listed in the information sharing area 308 to desired minimum required levels of trust, by drawing a line 312a, 312b, 312c from such items/delivery mechanisms to an appropriate area on the ranks of trust (ROT) graduated color bar 302.

In accordance with the principles of the present invention, if more items are available for the information sharing area 308 than can be displayed, then a scroll bar is added to the information sharing area 308 to allow a subscriber to scan through all available information items. Likewise, if more delivery mechanisms are available for the information reception area 310 than can be displayed, then a scroll bar is added to the information reception area 310 to allow a subscriber to scan through available delivery mechanisms.

As items (e.g. my location, my phone number, etc.) visible in an information sharing area 308/information reception area 310 are scrolled off the top or bottom of a display screen, rank of trust (ROT) lines 312a, 312b, 312c associated with those items/delivery mechanisms disappear. Likewise, as items/delivery mechanisms not visible in the information sharing area 308/information reception area 310 are scrolled onto the top or bottom of a display screen, rank of trust (ROT) lines 312a, 312b, 312c associated with those items/delivery mechanisms appear.

Once a line 312a, 312b, 312c is drawn from a delivery mechanism/information sharing item to the ranks of trust (ROT) graduated color bar 302, the line 312a, 312b, 312c can only be changed by grabbing the arrow head 314a , 314b , 314c and dragging the line 312a, 312b, 312c to a new spot on the ranks of trust (ROT) graduated color bar 302. The root 316a, 316b, 316c of a line 312a, 312b, 312c (attached to an information item or a delivery mechanism) drawn between a delivery mechanism/information item and the ranks of trust (ROT) graduated color bar 302 cannot be changed once the line 312a, 312b has been created. However, lines 312a, 312b, 312c drawn on the information control 300 can be deleted.

Information items that are listed in the information sharing area 308, but not linked to the ranks of trust (ROT) graduated color bar 302, are blocked from being shared. Likewise, delivery mechanisms that are listed in the information reception area 310, but not linked to the ranks of trust (ROT) graduated color bar 302, are blocked from being used (i.e. a subscriber may not receive content via such delivery mechanisms).

As depicted in FIG. 3, the information control 300 on the trusted circle information access management user interface 102 additionally displays a contacts with access box 318. In particular, a contacts with access box 318 preferably appears on the information control 300 whenever: a line 312a, 312b from an information sharing item to the ranks of trust (ROT) graduated color bar 302 is created, a line 312b from a delivery mechanism to the ranks of trust (ROT) graduated color bar 302 is created, and/or whenever a subscriber clicks or hovers a mouse over the ranks of trust (ROT) graduated color bar 302. A contacts with access box 318 lists all contacts and/or groups of contacts assigned to a relevant/clicked/hovered rank of trust (ROT).

The inventive trusted circle information access management user interface 102 allows users to define information dissemination and information reception controls without unduly complicating the interface 102. Contacts may access any information that is associated with a Rank of Trust (RoT) less than or equal to the contact's assigned Rank of Trust (RoT); information associated with a ROT greater than the contact's assigned ROT will be inaccessible to the contact. Likewise, Contacts may send information to the user using forms of information transfer associated with a ROT that is less than or equal to the contact's assigned ROT; forms of information transfer associated with a ROT that is greater than the contact's assigned ROT will be blocked such that info sent by the contact using that form of information transfer does not notify nor automatically display to the user. It is presumed that most users subscribed to the inventive trusted circle information access management user interface 102 will likely disallow any contacts for whom they have not assigned a rank of trust (ROT) to gain access to their shared content. Moreover, it is presumed that most users subscribed to the trusted circle information access management user interface 102 will likely permit content to be received (via email, IM, etc.) from most anybody, including contacts about whom they are neutral or whom they vaguely distrust. Inventive controls allow subscribers to easily block contacts whom they intensely distrust, as well as any contacts with whom they do not wish to share/receive information.

The inventive trusted circle information access management user interface 102 is extraordinarily easy to use and understand. The inventive interface 102 combines multiple dimensions of problems associated with dissemination of one's own information, as well as problems associated with filtering information received from others, into two straight forward, symmetric representations: designation of contacts to a particular level of trust and designation of a minimum level of trust required to share information with a contact and/or receive information from a contact.

While the invention has been described with reference to the exemplary embodiments thereof, those skilled in the art will be able to make various modifications to the described embodiments of the invention without departing from the true spirit and scope of the invention.

What is claimed is:

1. A trusted circle information access management user interface, comprising:
a spherical display on which to assign of a rank of trust (ROT) for each of a plurality of contacts by a location of placement of a contact icon representing each of said plurality of contacts;
a first information control for each of said plurality of contacts to stipulate a minimum rank of trust (ROT) each of said plurality of contacts must be assigned to be permitted access content shared by a user assigning said rank of trust; and
a second information control for each of said plurality of contacts to stipulate a minimum rank of trust (ROT) each of said plurality of contacts must be assigned to be permitted to send content to said user assigning said rank of trust.

2. The trusted circle information access management user interface according to claim 1, wherein:
said first information control and said second information control are adjusted together.

3. The trusted circle information access management user interface according to claim 1, wherein:
said first information control is represented with a graduated color bar.

4. The trusted circle information access management user interface according to claim 1, wherein:
said second information control is represented with a graduated color bar.

5. The trusted circle information access management user interface according to claim 1, wherein:
each of said plurality of contacts represents a user of a respective mobile device in a social network.

6. The trusted circle information access management user interface according to claim 1, wherein:
said content is a social network post.

7. The trusted circle information access management user interface according to claim 1, wherein:
said content is an instant message.

8. The trusted circle information access management user interface according to claim 1, wherein:
said content is an email.

9. The trusted circle information access management user interface according to claim 1, wherein said spherical display comprises:
a plurality of lines of latitude, each line of latitude representing a given rank of trust (ROT).

10. The trusted circle information access management user interface according to claim 9, wherein:
a line of latitude displayed in a southern hemisphere of said spherical display represents a distrusted level of rank of trust (ROT).

11. The trusted circle information access management user interface according to claim 9, wherein:
a line of latitude displayed in a northern hemisphere of said spherical display represents a trusted level of rank of trust (ROT).

12. The trusted circle information access management user interface according to claim 9, wherein:
each of said plurality of contacts is assigned said rank of trust (ROT) by dragging-and-dropping said respective contact icon onto a specific one of said plurality of lines of latitude.

13. The trusted circle information access management user interface according to claim 9, wherein:
each of said plurality of lines of latitude on said spherical display may be visually spun horizontally to scroll through all contacts assigned to a same rank of trust (ROT).

14. The trusted circle information access management user interface according to claim 1, wherein:
said information control displays at least one information types that said user permits to share with a given contact.

15. The trusted circle information access management user interface according to claim 1, wherein:
said information control displays at least one delivery mechanism by which that said user permits receipt of content from a given contact.

16. The trusted circle information access management user interface according to claim 15, wherein:
said delivery mechanism is email.

17. The trusted circle information access management user interface according to claim 15, wherein:
said delivery mechanism is a social network news feed.

18. The trusted circle information access management user interface according to claim 15, wherein:
said delivery mechanism is an instant messenger (IM) service.

19. The trusted circle information access management user interface according to claim 1, further comprising:
an analytics module to assign a recommended rank of trust (ROT) for each of said plurality of contacts.

20. A trusted circle sphere user interface, comprising:
a southern hemisphere;
a northern hemisphere;
a plurality of lines of latitude each depicting a different level rank of trust (ROT) for assignment to a plurality of contacts; and
a plurality of contact icons visually placed on said plurality of lines of latitude.

21. The trusted circle sphere user interface according to claim 20, wherein:
each of said plurality of contacts is assigned said rank of trust (ROT) by dragging-and-dropping a given one of said plurality of contact icons onto a desired one of said plurality of lines of latitude.

22. The trusted circle sphere user interface according to claim 20 wherein:
said plurality of lines of latitude displayed on said trusted circle sphere may be visually spun horizontally to view all contacts assigned to a same level of rank of trust (ROT).
